(19) United States
(12) Patent Application Publication
(10) Pub. No.: US 2024/0287641 A1
(43) Pub. Date: Aug. 29, 2024

(54) ARRANGEMENT AND METHOD FOR AIR-INDUCED EVAPORATION AND COOLING

(71) Applicant: METSO FINLAND OY, Espoo (FI)

(72) Inventors: Marika TIIHONEN, Espoo (FI); Tuomas HIRSI, Helsinki (FI)

(73) Assignee: METSO FINLAND OY, Espoo (FI)

(21) Appl. No.: 18/571,948

(22) PCT Filed: Jul. 1, 2021
(86) PCT No.: PCT/FI2021/050510

§ 371 Date: Dec. 19, 2023

(51) Int. Cl. C22B 3/02; B01D 1/14; B01D 3/06; B01D 53/14; C02F 1/06; C02F 103/16; C22B 3/00; C22B 3/04; C22B 3/22; C22B 11/00; C22B 15/00; C22B 26/12

(52) U.S. Cl. CPC C22B 3/02; B01D 1/14; B01D 3/06; B01D 53/14; C02F 1/06; C22B 3/04; C22B 3/22; C22B 11/04; C22B 15/0065; C22B 15/0086; C22B 23/0407; C22B 23/0453; C22B 26/12; C02F 2103/16

(57) ABSTRACT

An arrangement that is suitable for processing an aqueous metal-containing slurry to separate undesired fractions therefrom. The arrangement includes the units intended for cooling the slurry and simultaneously causing air-induced evaporation of a fraction of the water in the slurry. A method for processing an aqueous metal-containing slurry is disclosed using the arrangement.

### BACKGROUND OF THE INVENTION

### Field of the Invention

The present invention relates to an arrangement and a method for processing an aqueous metal-containing slurry, including the recirculation of at least a fraction of the liquid stream derived from the slurry.

### Description of Related Art

Hydrometallurgical processes for extracting metals from ores typically contain a step of pressure leaching at an elevated temperature. After such a pressure leaching, the dissolved components in solution are typically separated from the undissolved solids. However, such a separation step is carried out at atmospheric pressure and temperature. Therefore, the reaction mixture needs to be brought from the pressurized conditions to atmospheric conditions. Thus, typically, an intermediate cooling step with pressure decrease, and in some cases also a separate flashing step, is required.

Since large amounts of water typically circulate in such hydro-processes, it is also favorable to remove some of this water, e.g. by evaporation before the solid-liquid separation step, among others since a more concentrated process stream will lead to higher recoveries of metals.

Prior techniques for cooling often involve the use of cooling towers, cooling baffles or heat exchangers. When using cooling towers, the drift loss from the towers cannot be fully avoided, thus leading to large emissions or extensive gas cleaning. Since gas amounts from such cooling towers are very large, such a gas cleaning device also needs to be large. Heat exchangers in slurry pipelines, or cooling baffles inside a reactor, in turn, provide no further benefits beyond cooling, such as no evaporation, whereby the water contents of the slurries to be cooled remain the same. All of these commonly used cooling alternatives also require investing into separate cooling equipment, as existing equipment cannot be utilized.

There is thus an existing need for cooling techniques, that can be used in hydrometallurgical processes, wherein the equipment can be utilized more extensively than in prior techniques, e.g. in evaporations, and which provide streams that can be utilized in the circulations within the apparatus, thus providing significant further benefit beyond cooling.

### SUMMARY OF THE INVENTION

The invention is defined by the features of the independent claims. Some specific embodiments are defined in the dependent claims.

According to a first aspect of the present invention, there is provided an arrangement for processing a metal-containing slurry to cause recirculation of at least a fraction of the liquid stream passing through the arrangement, as well as a method for carrying out said processing.

According to a second aspect of the present invention, there is provided an arrangement and a method aiming at simultaneous cooling and partial evaporation in a slurry that has been obtained from a pressurized unit, while simultaneously carrying it to an atmospheric unit of the arrangement.

According to a third aspect, there is provided an arrangement and a method for processing a metal-containing slurry containing at least a fraction of recirculated material.

According to a fourth aspect, there is provided an arrangement and a method for processing a metal-containing slurry, by using an air feed to cause simultaneous efficient dispersion, cooling and partial evaporation.

The arrangement of the invention thus comprises the units intended for cooling a slurry and simultaneously causing air-induced evaporation of a fraction of the water in said slurry. Particularly, the arrangement includes one or more flash vessels, as well as an atmospheric mixing reactor, to which air is being fed, for dispersing said air into the slurry, as well as for causing air-induced evaporation of a fraction of the water in the slurry and simultaneously cooling of the slurry, thus providing a concentrated slurry and a fraction of off gas in the form of moist air, possibly containing also spent reaction gases.

Likewise, the method of the invention includes the steps required for adding the air to the slurry, and causing said simultaneous cooling and air-induced evaporation.

Several advantages are achieved using the present invention. Among others, a pressurized slurry processed in the described arrangement can be concentrated and cooled simultaneously, in the same equipment, while recovering some of the water of the slurry for further utilization.

It is important to evaporate a fraction of the water from the slurry, among others since this will result in a smaller amount of liquid in the slurry, and consequently a smaller amount of slurry. As a result, the amount of air needed in the present method is also smaller than in the commonly used cooling tower duty, whereby the amount of off-gas is smaller, not requiring such extensive devices and procedures for cleaning. Further, a more concentrated process stream will lead to a higher recovery of metals.

Since the air used in the resent method is dispersed into the slurry, contrary to spraying a solution, such as water, into a cooling tower, there is a significantly smaller amount of solution droplets in the off-gas.

Further, the direct contact of the air with the solution of the slurry causes the desired cooling via evaporation. This will, in turn, result in smaller emissions as well as economic benefits.

### BRIEF DESCRIPTION OF THE DRAWINGS

FIG. 1 is a diagram illustrating the units of the arrangement according to the invention.

FIGS. 2, and 3A and 3B are diagrams illustrating the units of arrangements according to embodiments of the invention.

FIG. 4 is a graph showing the slurry cooling times achieved when carrying out the air-induced evaporative cooling of the present invention.

### EMBODIMENTS OF THE INVENTION

### Definitions

In the present context, the term “metal-containing slurry” comprises aqueous slurries prepared from metal-containing ore, or slurries in the form of industrial streams, or recycled streams, or alternatively slurries being mixtures from two or more of these feed sources. The raw materials can be mineral or non-mineral.

The term “ore” is intended to include all natural rocks and sediments that contain one or more minerals, and that in the present invention contain one or more metals.

A “mineral slurry”, in turn, comprises aqueous slurries including at least a fraction that has been obtained from the processing of metal-containing ores. According to one alternative, the mineral slurry comprises either lithium (Li) or gold (Au), preferably lithium. According to another alternative, the mineral slurry comprises one or more of nickel (Ni), cobalt (Co), and copper (Cu).

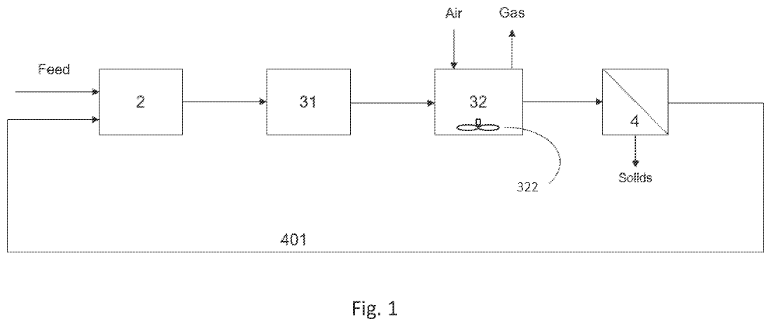

The present invention thus relates to an arrangement for processing an aqueous metal-containing slurry, including the lines for recirculating at least a fraction of the liquid stream passing through the arrangement (see FIG. 1), which arrangement comprises
a pressure leaching unit 2 for leaching the metal-containing slurry at an elevated pressure and elevated temperature, to provide a leached slurry,
one or more flash vessels 31, wherein the pressure and temperature of the leached slurry conducted to the vessel(s) 31 from the leaching unit 2 are decreased, thus providing an atmospheric leach slurry, an atmospheric mixing reactor 32, with an air inlet and mixing gear 322, for dispersing air into the atmospheric leach slurry conducted to the reactor from the flash vessel(s) 31, as well as for causing air-induced evaporation of a fraction of the water in the slurry and simultaneously cooling of the slurry, thus providing a concentrated slurry and a fraction of off-gas containing moist air,
a solid-liquid-separation unit 4, for separating the solids of the concentrated slurry from the solution, and
a recirculation line 401 for carrying at least a fraction of the solution obtained from the solid-liquid separation unit 4 back to the pressure leaching unit 2, optionally via one or more intermediate treatment units.

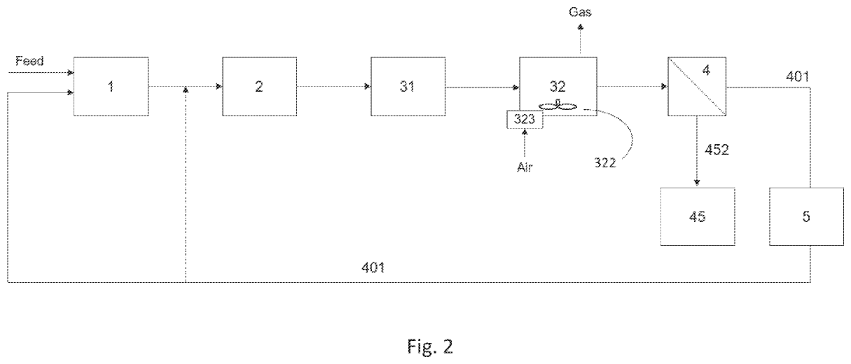

As indicated above, one or more optional intermediate treatment units may be positioned between the solid-liquid separation unit 4 and the pressure leaching unit 2. As illustrated in FIG. 2, one of these optional intermediate units may be in the form of a pulping unit 1, positioned upstream from the leaching unit 2, particularly intended for forming a slurry from a metal-containing feed.

Thus, as the recirculation line 401 typically is combined with a feed line leading to the leaching unit 2, this may take place at a position either upstream or downstream from any intermediate treatment units, preferably upstream or downstream from the optional pulping unit 1, the latter alternative indicated by a dotted arrow in FIG. 2, or these lines can be combined at both of these positions.

Since the leaching unit 2 is required to withstand high pressures, it is typically in the form of an autoclave, preferably with any required inlets for leaching reagents. Depending on the selected metal-containing feed, the leaching unit may also be required to withstand oxidative conditions.

The mixing reactor 32 can have a size that varies from very small to very large, but preferably has a diameter between 2 to 12 m, and a volume from 7 to 1600 m³. Optionally, more than one such reactors 32 can be connected to each other, either consecutively or in parallel.

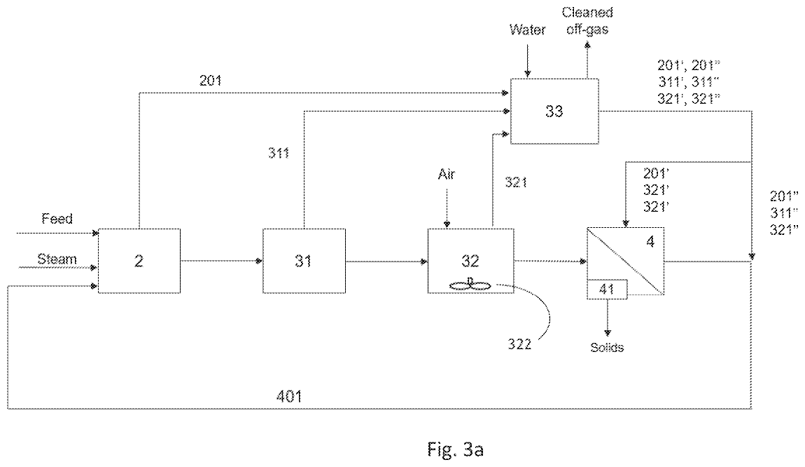

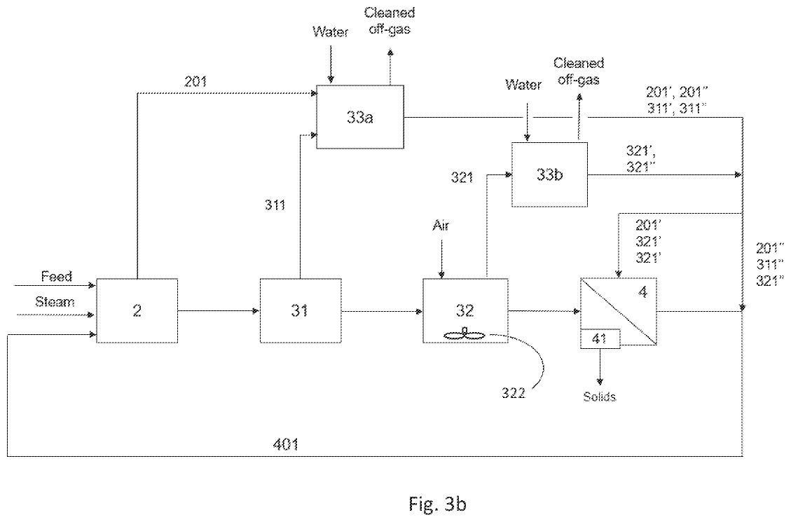

As indicated above, the atmospheric mixing reactor 32 needs an air inlet. Thus, also an outlet for the air is preferred, typically in the form of a line 321 (as shown in FIGS. 3A and 3B) for carrying off-gas containing moist air out from the reactor 32. Further, the reactor 32 requires mixing gear 322. The air inlet can be connected to a feed for fresh air, particularly to a feed of industrial plant air. The mixing gear 322 of the atmospheric mixing reactor 32 are preferably in the form of a type of agitator, more preferably in the form of an impeller.

To ensure efficient function of the atmospheric mixing reactor 32, its air inlet is preferably connected to a gas pressurizer 323 for pressurizing the air feed (see FIG. 2). Said air inlet is typically positioned at the lower half of the mixing reactor 32, preferably at a position below the slurry surface in the unit 32. More preferably, the air inlet is positioned below the mixing gear 322. These preferred positions facilitate the capability of the mixing reactor 32 to decrease air bubble size. The smaller bubbles will, in turn, provide a more efficient function of the reactor 32 in dispersing air causing evaporation and cooling the slurry.

In an embodiment of the invention shown in FIG. 3A, at least one of the leaching unit 2, the flash vessel 31 and the atmospheric mixing reactor 32 is connected to off-gas handling systems 33, preferably via line 201 for carrying off-gas from the pressure leaching unit 2 to the off-gas handling system 33, or via line 311 for carrying off gas in the form of steam from the flash vessel 31 to the off-gas handling system 33, or via line 321 for carrying the off-gas in the form of moist air from the mixing reactor 32 to the off-gas handling system 33.

Each off-gas handling system 33 is preferably in the form of a scrubber, more preferably a wet scrubber, and most suitably a venturi scrubber. Particularly the flash vessel 31 and the atmospheric mixing reactor 32 benefit from such connections. Each of these off-gas handling systems 33 are typically equipped with water inlets, since washing water is needed in these systems.

In a preferred embodiment, as shown in FIG. 3B, at least one, or preferably both, of the leaching unit 2 and the flash vessel 31 is connected to a high-pressure off-gas handling system 33a. Likewise, it is preferred that the atmospheric mixing reactor 32 is connected to an atmospheric off-gas handling system 33b. Although FIG. 3 implies that a single system 33a is connected to both the leaching unit 2 and the flash vessel, these systems 33a can be separate, or either one of them can be dispensed with.

In said off-gas handling system(s) 33, the off-gases of the one or more of the leaching unit 2, the flash vessel(s) 31 and the mixing reactor 32 can be washed, whereby spent washing water, combined with water from the off-gases, can be recovered and reused.

FIGS. 3A and 3B also emphasize the need for evaporation, in showing a steam inlet leading to the pressure leaching unit 2. This steam can be used as a preferred manner of heating the slurry in the leaching unit 2, but simultaneously brings further water into the slurry, which excess moisture needs to be removed in order to provide an efficient metal recovery.

The solid-liquid separation unit 4 is essential for separating the solids of the processed slurry from the liquid, i.e. for separating the solids of the concentrated slurry obtained from the mixing reactor 32 from the liquid, thus enabling an efficient recovery of the desired fractions, e.g. metals, from the slurry. The previous units of the arrangement are required since this separation takes place at atmospheric conditions.

Preferably, the separation unit 4 is equipped with a washing section 41 having a water inlet, the washing section being capable of washing the solids of the slurry, thus adding washing water to the solution already separated from the solids. This will provide higher yields of the desired fractions in the solution, and lower yields of impurities and by-products in the solids, whereby a benefit can be achieved regardless of the fraction(s) to be recovered.

The separation unit 4, with its optional washing section 41, is preferably in the form of a filtration device.

The separation unit 4, or preferably its washing section 41, is preferably connected to one or more of the off-gas handling systems 33. This can be achieved using lines 201′,311′,321′ which lead from the off-gas handling system(s) 33, 33a, 33b to the solid-liquid separation unit 4, preferably to a washing section 41 therein, for reuse of at least a fraction of the water recovered from the off-gas handling system (33, 33a, 33b).

In an alternative embodiment, lines 201″,311″,321″ can be used to connect the off-gas handling system(s) 33, 33a, 33b to the recirculation line, wherein at least a fraction of the water recovered from the off-gas handling system 33, 33a, 33b is combined with the recirculated solution in the recirculation line 401.

Also both of these alternatives can be used simultaneously, for carrying a fraction of the water recovered from the off-gases to the separation unit 4 and another fraction to the recirculation line 401.

In an embodiment shown in FIG. 2, the arrangement of the invention also includes one or more intermediate treatment units in the form of metal recovery unit(s) 5, preferably for recovering one or more of copper, nickel and cobalt from the solution obtained from the solid-liquid separation unit 4. These metal recovery unit(s) 5 preferably comprise also one or more purification subunit(s) before the actual recovery of the metal(s) takes place.

In an alternative embodiment, also shown in FIG. 2, the separation unit 4 is connected from a solids recovery area therein to a solids recovery line 452, intended to carry the solids obtained from the separation unit 4 to one or more metal recovery units 45, preferably for recovering either lithium or gold from said solids. Also these metal recovery unit(s) 45 may comprise purification subunit(s).

Although they are shown in the same FIG. 2, these metal recovery units 5, 45 are typically not included in the same arrangement. They are instead linked to separate alternatives, based on the used feed.

The invention also relates to a method for processing an aqueous metal-containing slurry to separate undesired fractions therefrom and to recirculate at least a fraction of the liquid stream being passed through the steps of the method, in which method the above described arrangement can be utilized. This method comprises
leaching the metal-containing slurry at an elevated pressure and elevated
temperature, to provide a leached slurry,
flashing the leached slurry to decrease its pressure and provide an atmospheric leach slurry,
agitating the atmospheric leach slurry, while simultaneously feeding air into the slurry, to disperse the air into the slurry, as well as to cause air-induced evaporation of a fraction of the water in the slurry and cooling of the slurry and, thus providing a concentrated slurry and a fraction of off-gas containing moist air, and
separating the solids of the slurry from the solution, and further
recirculating at least a fraction of the solution obtained from the solid-liquid separation step to the pressure leaching step, optionally via one or more intermediate treatment steps.

The metal-containing slurry is typically selected from industrial streams. It can be prepared from metal-containing ore, or it can be an industrial stream obtained from another industrial process. Alternatively, the slurry can contain or consist of one or more recycled streams. Further, a mixture of slurries obtained or prepared from two or more of these sources can be used. Preferably, the metal-containing slurry is a mineral slurry, optionally containing recycled material, wherein at least a fraction of the slurry has been obtained from the processing of metal-containing ore or rock.

Thus, the metals of the metal-containing slurry typically comprise metals that can be recovered in useful yields from ores using common industrial recovery procedures. According to one alternative, the metal-containing slurry thus comprises either lithium (Li) or gold (Au), preferably at least lithium. According to another alternative, the metal-containing slurry comprises one or more of nickel (Ni), cobalt (Co) and copper (Cu).

The feed is supplied as a slurry to the leaching step either as such or it may have been combined with the recirculated solution before feeding to the leaching step, whereby no separate inlet is required for the recirculated solution on the leaching unit 2. Since the feed may take part in one of said intermediate treatment steps, the combination of feed with recirculated solution may even take place already before such an intermediate treatment step.

In an embodiment of the invention, a pulping step is carried out as an intermediate processing step. In this embodiment, at least a fraction of the feed being supplied to the leaching step is added to the pulping step, whereas some recycled streams may be added directly to the leaching step. By using this pulping step, and adding at least a fraction of the recirculated solution to the pulping step, said solution can be used in forming a slurry from the feed.

The leaching step is carried out with agitation and typically while using one or more leaching reagents. Preferably, heating and pressurization are used. A suitable temperature for the leaching is 100 to 250° C., preferably a temperature of 150 to 230° C., and more preferably a temperature of 200 to 220° C. A suitable pressure is, in turn, 2 to 60 bar, preferably 10 to 30 bar, and more preferably 15 to 25 bar.

The temperature and the pressure of the leaching are typically selected based on the metals of the feed. For example, nickel-containing slurries are typically leached at temperatures ranging from 100° C. to 200° C., whereas lithium or gold are typically leached at temperatures >150° C. Gold and other precious metals, in turn, typically require higher pressures, such as pressures of 30-60 bar, whereas lithium commonly is leached at pressures of 10-30 bar, or preferably 15-25 bar.

Also the leaching reagents are selected based on the metals of the feed. Lithium is thus typically leached in the presence of an alkali metal carbonate, preferably sodium or potassium carbonate, more preferably being at least partly composed of sodium carbonate. Nickel, cobalt and copper are, in turn, typically leached in oxidative conditions, preferably by adding an acid as well as an oxygen-containing gas.

In case of using a separate pulping step, some of the leaching reagents, such as the alkali metal carbonate used for leaching lithium-containing slurries, can be mixed with the feed already in the pulping step, thus obtaining an aqueous slurry containing the required reagents already before the slurry is conducted to the leaching step.

The flashing step is carried out in conditions that provide a slurry at atmospheric pressure and at a temperature below the boiling point of the slurry. This flashing step is a procedure used to bring the slurry from the pressurized and heated conditions of the leaching step towards the atmospheric conditions of the following agitation step.

The subsequent agitation is carried out in conditions that provide a cooled concentrated slurry having a temperature of 70 to 100° C., preferably 85 to 95° C. Since one of the aims of the agitation step is to provide a more concentrated slurry, thus facilitating the following separation step, a partial evaporation of the water in the slurry is desired. It has now been found that a suitable amount of evaporation can be achieved by dispersing air into the slurry. Moisture will then leave the agitation step with the off-gas. This moisture is suitable for recovery and reuse, e.g. as washing water in another step of the process, preferably the separation step.

In order to provide an efficient cooling, it is preferred to feed air into the agitation step that has a temperature that is lower than the temperature of the slurry in the agitation step, preferably below 50° C., more preferably below 25° C. In theory, the temperature range of the air does not have a lower limit. However, as outdoor atmospheric air is typically used, the lower end of the temperature range is typically limited by outdoor temperatures, such as temperatures of ≥−30° C.

The amount of gas in the air feed is dependent, among others, of the gas dispersion properties of the agitator or the mixing reactor 32. The target is to disperse into the mixing reactor 32 an amount of air that is feasible to ensure a maximum amount of water evaporation, and thus optimal level of cooling in the slurry. This level of gas flow to be injected into the agitator and estimated to provide said maximum economical gas flow, per hour, is between 10 and 35 m³ of gas per m³ of agitator volume, preferably being 10-20 m³ gas/h/m³ of the reactor (32). Thus, within this range for the gas flow, it has been confirmed that the evaporation is most efficient, particularly with the above described equipment.

The amount of gas fed into the agitator is strongly dependent on the agitator size when using the typical agitators currently on the market, but this may change if more efficient agitators are taken into use. The mixing reactor 32 can thus have a size that varies from very small to very large, but in order to maintain an efficient overall process, and a reasonable agitator engine size, it is preferred to use a reactor 32 having a diameter between 2 to 12 m, and a volume from 7 to 1600 m³. Optionally, more than one such reactors 32 can be connected to each other, either consecutively or in parallel.

As described above, the off-gas obtained from the mixing step, containing moist air and possibly also spent reaction gases, can be recovered, and the moisture reused. Off-gases can, however, be recovered also from the flashing step, mainly as steam, but possibly including also spent reaction gases, and even from the leaching step, although the amounts from the latter are typically small. These off-gases are preferably treated before reuse, more preferably by washing them in an off-gas handling step, most suitably carried out as wet scrubbings. It is possible to combine off-gases from more than one source, but preferably, they are treated separately, at least so that the off-gas from the mixing step is treated separately from the others. In a particularly preferred alternative, the treatment of the off-gases take place under pressure for the off-gases of the leaching step and the flashing step, whereas the treatment of the off-gases takes place at atmospheric pressure for the off-gases of the mixing step.

Following a treatment of the off-gases, preferably carried out as a washing, with continuous water addition, a water fraction can be recovered from each off-gas treatment step, this water fraction containing also moisture from the off-gases. The recovered water fraction is then preferably reused, either as water used in the separation step, or preferably a washing step linked to the separation step, or the water fraction can be added to the recirculated solution that is recirculated via optional intermediate treatment step(s) to the leaching step.

The solid-liquid separation step is carried out in order to provide separate solids and solution fractions, whereby desired metals can be recovered from one of the separate fractions. Preferably, the solid-liquid separation step includes washing the solids with water. As stated above, the water used in the optional washing step can be water recovered from the optional off-gas handling step(s).

In order to recover metals from one of the separated fractions, two alternatives exist. Either the recovered solids are processed further in a metal recovery step, preferably by leaching, in order to recover e.g. lithium or gold from said solids, or the solution obtained from the separation step is recirculated to the leaching step via a metal recovery step, preferably for recovering one or more of copper, nickel and cobalt from the solution obtained from the separation step, more preferably by solvent extraction. Each of these metal recoveries may include also purifications of the streams before the actual metal recoveries take place.

In a particularly preferred embodiment of the present invention, the above described method is carried out in the arrangement also described above.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided to provide a thorough understanding of embodiments of the invention. One skilled in the relevant art will recognize, however, that the invention can be practiced without one or more of the specific details.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The following non-limiting example is intended merely to illustrate the advantages obtained with the embodiments of the present invention.

### Example—Effect of Air Cooling of the Slurry

Two batch tests were done to demonstrate the air cooling effect for a pressure leach slurry representative of alkaline spodumene pressure leach process slurry. The leach slurry preparation and autoclave leach were done batch wise as follows: Leaching reagent sodium carbonate (4000 g) was dissolved to water and 15 000 grams of 6.5% Li₂O calcined (beta-) spodumene concentrate was added to prepare an aqueous slurry, of 60 liters' total volume. The slurry was fed into an autoclave and leached for >1 hour at >200° C.

The cooling test setup consisted of 20-liter agitated reactor, which was filled with the authentic leach slurry originating from the previous pressure leaching process step. The test slurry was constantly agitated and test time was started at near boiling point (95° C.). The test equipment was made of stainless steel and it was not insulated nor a totally closed system: there was a free vent line/opening to the fume hood. The 0 liters per min test was done, in order to monitor the slurry cooling via natural heat loss through the walls and via evaporation off the slurry surface. The test was repeated by feeding constant 4.25 liters of air per minute to the slurry. The air feed was disperged by agitation. Agitation speed was rpm identical in both tests. The air feed was dry air, at 21° C. from pressurized air network.

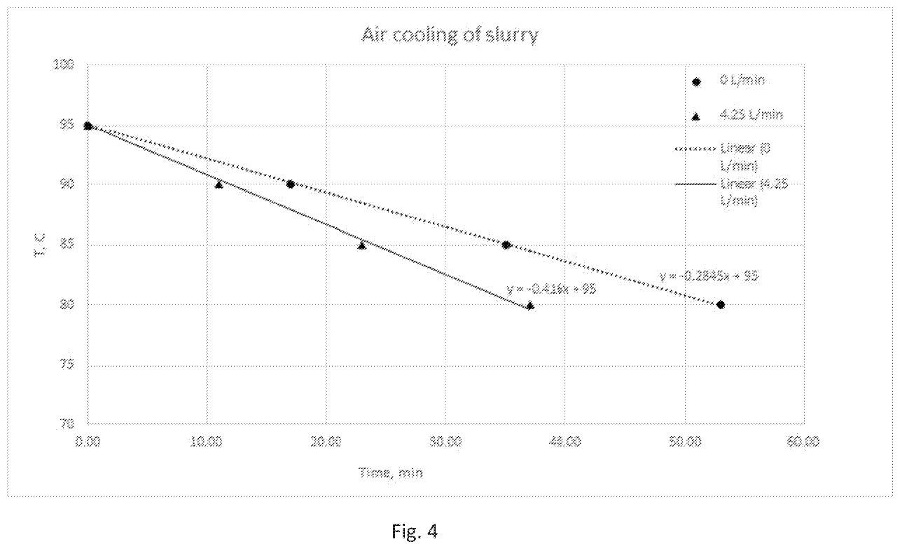

FIG. 4 shows the slurry cooling times from 95° C. to 80° C. with the applied 4.25 l/min air feed and with 0 l/min air feed, resulting: 37 min and 53 min, respectively and the cooling (degrees) achieved per minute was 0.416° C./min and 0.285° C./min, respectively.

The amount of evaporated water was: 0.6 liters in test 0 and twice as much: 1.2 liters in test with 4.25 liters per minute air fed.

The advantages thus obtained with such an air-induced procedure include that an efficient evaporation is achieved using a simple reactor and a small reactor volume.

In the case of the lithium recovery, as shown in this example, further advantages include smaller reagent consumption and higher lithium recovery.

### Industrial Applicability

The present arrangement can be used as a part of any industrial arrangements including a pressurized leaching unit followed by a solid-liquid separation unit maintained at atmospheric pressure, and generally for gently depressurizing the slurry carried from the leaching unit to the atmospheric separation unit.

In particular, the present arrangement is useful in simultaneously causing cooling and depressurization of the slurry carried from the leaching unit to the atmospheric separation unit, while also causing evaporation of a fraction of the moisture of the slurry, which moisture can be reused.

### REFERENCE SIGNS LIST

As shown in the FIGS. 1-3, the following units can be included in the arrangement of the present invention, according to one or more embodiments of the invention:
1 Optional pulping unit
2 Pressure-leaching unit,
   201, 201′,201″ Optional line for off-gas
31 Flash vessel
   311, 311′,311″ Optional line for off-gas
32 Atmospheric mixing reactor, with
   321, 321′,321″ Optional line for off-gas
   322 Mixing gear, and
   323 Optional gas pressurizer
33 Optional off-gas handling system, either in the form of
   33a A high-pressure off-gas handling system, or
   33b An atmospheric off-gas handling system
4 Solid-liquid separation unit
   41 Optional washing section
401 Recirculation line
45 Optional metal recovery unit, with
   452 Optional solids recovery line
5 Optional metal recovery unit

1. An arrangement for processing an aqueous metal-containing slurry, including the lines for recirculating at least a fraction of the liquid stream passing through the arrangement, which arrangement comprises:
a pressure leaching unit for leaching the metal-containing slurry at an elevated pressure and elevated temperature, to provide a leached slurry,
one or more flash vessels, wherein the pressure and temperature of the leached slurry conducted to the vessel(s) from the leaching unit are decreased, thus providing an atmospheric leach slurry,
an atmospheric mixing reactor, with an air inlet and mixing gear, for dispersing air into the atmospheric leach slurry conducted to the reactor from the flash vessel(s), as well as for causing air-induced evaporation of a fraction of the water in the slurry and simultaneously cooling of the slurry, thus providing a concentrated slurry and a fraction of off-gas containing moist air,
a solid-liquid-separation unit, for separating the solids of the concentrated slurry from the solution, and
a recirculation line for carrying at least a fraction of the solution obtained from the solid-liquid separation unit back to the pressure leaching unit, optionally via one or more intermediate treatment units.

2. The arrangement according to claim 1, which includes an intermediate treatment unit in the form of a pulping unit, positioned upstream from the leaching unit.

3. The arrangement according to claim 1, wherein the recirculation line is combined with the feed line leading to the leaching unit-(2), at a position either upstream or downstream from any intermediate treatment units, or at both positions.

4. The arrangement according to claim 1, wherein the leaching unit is an autoclave.

5. The arrangement according to claim 1, wherein the air inlet of the atmospheric mixing reactor is connected to a gas pressurizer for pressurizing the air feed.

6. The arrangement according to claim 1, wherein the air inlet of the atmospheric mixing reactor is positioned at the lower half of the mixing reactor, as indicated by the height of the reactor.

7. The arrangement according to claim 1, wherein the air inlet of the atmospheric mixing reactor is positioned below used mixing gear.

8. The arrangement according to claim 1, wherein at least one of the leaching unit, the flash vessel and the atmospheric mixing reactor is connected to an off-gas handling system, each off-gas handling system preferably being in the form of a scrubber, more preferably a wet scrubber.

9. The arrangement according to claim 1, wherein at least one, or preferably both, of the leaching unit and the flash vessel is connected to a high-pressure off-gas handling system.

10. The arrangement according to claim 1, wherein the atmospheric mixing reactor is connected to an atmospheric off-gas handling system.

11. The arrangement according to claim 1, wherein the solid-liquid separation unit is equipped with a washing section having a water inlet, the washing section being capable of washing the solids of the slurry and adding the washing water to the separated solution.

12. The arrangement according to claim 1, which comprises a line for carrying off-gas from the pressure-leaching unit to an off-gas handling system.

13. The arrangement according to claim 1, which comprises a line for carrying off gas in the form of steam, possibly including spent reaction gases, from the flash vessel to an off-gas handling system.

14. The arrangement according to claim 1, which comprises a line for carrying the off-gas in the form of moist air, possibly including spent reaction gases, from the mixing reactor to an off-gas handling system.

15. The arrangement according to claim 12, wherein a line leads further from the off-gas handling system to the solid-liquid separation unit, preferably to a washing section therein, for reuse of at least a fraction of the water recovered from the off-gas handling system.

16. The arrangement according to claim 12, wherein a line leads further from the off-gas handling system to the recirculation line, wherein at least a fraction of the water recovered from the off-gas handling system is combined with the recirculated solution in the recirculation line.

17. The arrangement claim 1, which includes one or more intermediate treatment units in the form of metal recovery unit(s), preferably for recovering one or more of copper, nickel and cobalt from the solution obtained from the solid-liquid separation unit.

18. The arrangement according to claim 1, wherein the separation unit is connected from a solids recovery area therein to a solids recovery line, intended to carry the solids obtained from the separation unit to one or more metal recovery units, preferably for recovering either lithium or gold from said solids.

19. A method for processing an aqueous metal-containing slurry to separate undesired fractions therefrom and to recirculate at least a fraction of the liquid stream being passed through the steps of the method, which method comprises:
leaching the metal-containing slurry at an elevated pressure and elevated temperature, to provide a leached slurry,
flashing the leached slurry to decrease its pressure and temperature and provide an atmospheric leach slurry,
agitating the atmospheric leach slurry, while simultaneously feeding air into the slurry, to disperse the air into the slurry, as well as to cause air-induced evaporation of a fraction of the water in the slurry and cooling of the slurry, thus providing a concentrated slurry and a fraction of off-gas containing moist air, and
separating the solids of the slurry from the solution, and further
recirculating at least a fraction of the solution obtained from the solid-liquid separation step to the pressure leaching step, optionally via one or more intermediate treatment steps.

20. The method according to claim 19, wherein the aqueous metal-containing slurry is prepared from metal-containing ore, or it is obtained from industrial streams, or it is a recycled stream, or alternatively it is a mixture of slurries obtained or prepared from two or more of these sources.

21. The method according to claim 19, wherein the metal-containing slurry is a mineral slurry, wherein at least a fraction of the mineral has been obtained from the processing of metal-containing ores.

22. The method according to claim 19, wherein the metal-containing slurry comprises either lithium (Li) or gold (Au), preferably lithium.

23. The method according to claim 19, wherein the metal-containing slurry comprises one or more of nickel (Ni), cobalt (Co) and copper (Cu).

24. The method according to claim 19, wherein at least a fraction of the solution obtained from the separation step is recirculated to the pressure-leaching step via a pulping step, wherein the solution is used in forming a slurry from a feed supplied to the leaching step.

25. The method according to claim 24, wherein the feed supplied to the leaching step is combined with the recirculated solution either before or after the pulping step is carried out, preferably so that at least a fraction of the recirculated solution is combined with the feed before the pulping step.

26. The method according to claim 19, wherein the leaching step is carried out at a temperature of 100 to 250° C., preferably at a temperature of 150 to 230° C., and more preferably at a temperature of 200 to 220° C.

27. The method according to claim 19, wherein the leaching step is carried out at a pressure of 2 to 60 bar, preferably 10 to 30 bar, and more preferably 15 to 25 bar.

28. The method according to claim 19, wherein the flashing is carried out in conditions that provide a slurry at atmospheric pressure and at a temperature below the boiling point of the slurry.

29. The method according to claim 19, wherein the agitation is carried out in conditions that provide a cooled concentrated slurry having a temperature of 70 to 100° C., preferably 85 to 95° C.

30. The method according to claim 19, wherein the amount of gas in the air feed to the agitation step is adjusted to a level of 10-35 m³ of gas flow per hour per m³ of the used mixing reactor, preferably to a level of 10-20 m³ gas/h/m³ of reactor.

31. The method according to claim 19, wherein the solid-liquid separation step includes washing the solids with water.

32. The method according to claim 19, wherein the solids are recovered after the separation step, and are processed further in a metal recovery step, preferably by leaching, more preferably for recovering either lithium or gold from said solids.

33. The method according to claim 19, wherein the off-gas fraction containing moist air obtained from the agitation step is washed in an off-gas handling step, preferably being carried out as a wet scrubbing.

34. The method according to claim 19, wherein an off-gas fraction is obtained from the pressure-leaching step, and is washed in an off-gas handling step, preferably carried out as a wet scrubbing.

35. The method according to claim 19, wherein an off-gas fraction containing steam is obtained from the flashing step, and is washed in an off-gas handling step, preferably carried out as a wet scrubbing.

36. The method according to claim 33, wherein water recovered from the off-gas handling step(s) is reused as water in the separation step, preferably in washing the solids separated from the solution.

37. The method according to claim 19, wherein at least a fraction of the solution obtained from the separation step is recirculated to the pressure-leaching step via a metal recovery step, preferably for recovering one or more of copper, nickel and cobalt from the solution obtained from the separation step, more preferably by solvent extraction.

38. The method according to claim 19, which is carried out in the arrangement of claim 1.
